(19) United States
(12) Patent Application Publication
(10) Pub. No.: US 2018/0007578 A1
(43) Pub. Date: Jan. 4, 2018

(54) Machine-to-Machine Anomaly Detection

(71) Applicant: Alcatel-Lucent USA Inc., Murray Hill, NJ (US)

(72) Inventors: Lawrence M. Drabeck, Oceanport, NJ (US); Glenn Bruns, Marina, CA (US)

(73) Assignee: Alcatel-Lucent USA Inc., Murray Hill, NJ (US)

(21) Appl. No.: 15/198,066

(22) Filed: Jun. 30, 2016

(51) Int. Cl. H04W 28/02; H04L 12/24; H04L 12/851; H04W 4/00

(52) U.S. Cl. CPC H04W 28/0215; H04W 4/005; H04L 41/065; H04L 47/2441

(57) ABSTRACT

A method and apparatus for configuring an anomaly detector by constructing a classifier using supervised learning and applying that classifier to classify M2M traffic as either “anomalous” or “non-anomalous” with respect to a particular host. Anomaly detection is provided using one or more constructed classifiers. Each classifier is akin to an object that supports two main operations: (1) train: given a set of labeled feature vectors, construct a classifier; and (2) classify: given a feature vector, output a particular classification (i.e., result) selected from two classes defined as anomalous or non-anomalous. A non-anomalous result is indicative of host flow data that is typically associated with a particular host (i.e., safe traffic). An anomalous result is indicative of host flow data that is not typically associated with a particular host (i.e., unsafe traffic).

### TECHNICAL FIELD

The present invention relates generally to machine-to-machine (M2M) communications, and, more particularly, but not exclusively, to anomaly detection in M2M network traffic.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Today, M2M communications are becoming an increasingly large fraction of communications network traffic including wireless network traffic. Given that typical M2M traffic is initiated by software (e.g., applications executing on a wireless device such as a smartphone), these software applications have the potential to disrupt network operations in any number of ways. For example, a bug, application design flaw, or malware resident in M2M software executing on one or more client devices can cause the client device to behave abnormally and/or disrupt network operations for all users across a particular communications network. Consequently, network service providers and enterprises that depend on M2M communications for their business platforms have a strong interest in monitoring and staying informed of anomalies in M2M network traffic.

However, staying informed with respect to anomalies in M2M network traffic can be a challenging task. A starting definition for “M2M” might be “machine-initiated network communications”. In an extreme case, what initiates traffic might be a timer associated with a client device. For example, an electric metering device might be programmed to contact the network once every hour to initiate data transmission. Alternatively, M2M traffic might be initiated by a condition based on many inputs, for example, a device in a power plant might report on plant operating conditions whenever temperature or pressure readings exceed specified norms. Further, for example, game software executing on a smart phone might contact the network, without the knowledge of the user, when a user begins a networked game. In this scenario, the traffic may be considered M2M given the user was not aware of the network traffic and did not attempt to initiate the network communication per se.

As to anomalies, in one sense, an anomaly is simply a statistical concept—anything that is unlikely can be considered an anomaly. That is, even if a probability can be assigned to the pattern of traffic from a user, the definition of a probability threshold that would define the traffic as anomalous may not be clear. Also, given an arbitrary collection of points in an n-dimensional features space, the ability to assign probabilities to these points is also questionable. Further, in attempting to resolve the definition challenge, user traffic might be classified as falling into a group of different patterns, however, this raises the further consideration as to how many users must share a pattern for that group's activity to be considered anomalous.

Therefore, a need exists for an improved technique for providing anomaly detection in M2M network traffic environment that will address the inherent challenges associated with M2M systems, M2M devices, M2M traffic and anomaly characteristics and classification.

### BRIEF SUMMARY OF THE EMBODIMENTS

In accordance with various embodiments, a method and apparatus is provided for configuring an anomaly detector by constructing a classifier using supervised learning and applying that classifier to classify M2M traffic as either “anomalous” or “non-anomalous” with respect to a target host.

In accordance with an embodiment, anomaly detection is provided using one or more constructed classifiers. Each classifier is akin to an object that supports two main operations: (1) train: given a set of labeled feature vectors, construct a classifier; and (2) classify: given a feature vector, output a particular classification (i.e., result) selected from, illustratively, two classes are defined as “anomalous” or “non-anomalous”. The “train” operation constructs a classifier object using host flow data, and the “classify” operation is the anomaly detection operation. A non-anomalous result is indicative of host flow data that is typically associated with a particular host and, therefore, not indicative of problematic, abnormal, or other potentially disruptive traffic (i.e., safe traffic). An anomalous result is indicative of host flow data that is not typically associated with a particular host and, therefore, indicative of problematic, abnormal or other potentially disruptive traffic (i.e., unsafe traffic).

In accordance with an embodiment, a classifier is configured by at least the following operations: (i) for each input, compute a feature vector; (ii) label each feature vector with a class; (iii) randomly select some of the labeled feature vectors to form a training set; and (iv) train the classifier using the training set. In accordance with the embodiment, an “input” consists of one or more flow records from the data received by a host from a user. Each classifier that is configured is associated with a particular one host. As used herein “classifier host” shall refer to the specific host associated with the specific classifier, and in turn, “host classifier” shall refer to the specific classifier associated with a specific host. The feature vector computed from an input is a sequence of feature values. In accordance with the embodiment, given a particular M2M host and a user, a set of all flow records associated with both that user and host are collected. As used herein, an “M2M host” designates a host that is exchanging machine-to-machine communications (e.g., wireless network communications traffic) associated with a specific IP address (e.g., a computer or other device associated with a specific address) as opposed to a domain name that may be associated with a large set of devices. A flow record consists of information regarding a transmission control protocol (TCP) or a user datagram protocol (UDP) flow such as flow start time, source IP address and port, destination IP address and port, data and packets transmitted, to name just a few. These records are then aggregated by the time window to which they are associated with, and for each user, host, and time window, a feature vector is computed. Thus, in accordance with the embodiment, each feature vector is identified by a host, a user identification, and a time window.

In accordance with the embodiment, a set of host flow data is obtained and feature vectors are computed. In this case, the feature vectors are unknown in terms of whether they are “anomalous” or “non-anomalous” (as opposed to the training operation set forth above that utilizes and associates a known host with a known set of feature vectors). As such, these feature vectors are examined with one or more host classifiers (as constructed as set forth above) to determine and classify each as either anomalous or non-anomalous with respect to the target host. Essentially, in accordance with the embodiment, the anomaly detector (i.e., host classifier) created for one M2M host (i.e., the classifier host) will report as anomalous communications traffic from one or more clients (users) of other M2M hosts. In this way, the M2M communications traffic is monitored and anomaly detection facilitated with more predictable results and increased accuracy.

These and other advantages of the embodiments will be apparent to those of ordinary skill in the art by reference to the following detailed description and the accompanying drawings.

### BRIEF DESCRIPTION OF THE DRAWINGS

FIG. 1 shows an illustrative M2M host discovery data set in accordance with an embodiment;

FIG. 2 shows, in accordance with an embodiment, exemplary features in an illustrative feature set associated with a particular M2M host of FIG. 1;

FIG. 3 shows, in accordance with an embodiment, a flowchart of illustrative operations for anomaly detection from flow data associated with a particular M2M host of FIG. 1;

FIG. 4 shows, in accordance with an embodiment, an illustrative classification tree for anomaly detection as applied to one exemplary feature of the feature set of FIG. 1;

FIG. 5 shows four examples of graphs resulting from the application of Naive Bayes classification to each of four example features of the feature set of FIG. 1 in a host classifier for anomaly detection in accordance with an embodiment;

FIG. 6 shows a graph of detected anomalies in a number of flow records associated with an M2M host in accordance with an embodiment;

FIG. 7 shows a graph of detected anomalies in traffic to a host in accordance with an embodiment;

FIG. 8 shows a display interface for an anomaly detection application, including an illustrative display of anomalies detected using Naive Bayes classification, in accordance with an embodiment, e.g. as implemented in the computing device of FIG. 10;

FIG. 9 shows a display of anomalies, using the display interface of FIG. 8, detected using a tree classifier in accordance with an embodiment;

FIG. 10 is a high-level block diagram of an exemplary computer in accordance with an embodiment, e.g. configured to implement the Naive Bayes classification methodology and display interface of FIG. 9; and

FIG. 11 is a diagram of an illustrative anomaly detection environment in accordance with an embodiment, e.g. including a number of M2M client devices, a number of M2M hosts, and an anomaly detector work station including the computer of FIG. 10.

### DETAILED DESCRIPTION

In accordance with various embodiments, a method and apparatus is provided for configuring an M2M traffic anomaly detector by, e.g., configuring a classifier using supervised learning and applying that classifier to classify M2M traffic as either “anomalous” or “non-anomalous” with respect to a target host.

Essential to the detection of anomalies for a particular M2M host is the ability to distinguish M2M hosts from non-M2M hosts (not exchanging M2M traffic) in a communications network. In accordance with an embodiment a heuristic approach is utilized to identify M2M host(s). In particular, a set of metrics is selected based on their potential association with M2M hosts, and values for these metrics are computed from network data representing traffic between M2M clients and M2M hosts. From these computed values, in accordance with an embodiment, a weighted average is computed to form an overall M2M score that represents an indication as to whether a particular host is an M2M host or not. In particular, a host with a higher M2M score is more likely to be an actual M2M host as compared to hosts with lower computed M2M scores.

For example, the following metrics may be determined from the network traffic and used for identifying M2M hosts:
Regularity of traffic size: M2M hosts are likely to have traffic that is regular with respect to the number of upstream (i.e., to the host) and downstream (i.e., to the user or client) bytes transmitted. For example, the electricity usage reports from a wireless meter will tend to be the same size. A web site may receive requests of about the same size, but will likely produce responses of many sizes. A related concept of traffic regularity is the regularity in the ratio of traffic in the upstream to the traffic in the downstream.
Users with low diversity: Users of M2M hosts are likely to communicate with a small number of hosts. For example, an electricity meter will tend to communicate with a single host to report electrical usage. In contrast, humans tend to visit and access many hosts.
Few unique device types: Users of M2M hosts are likely to use only a small number of device types. For example, the wireless transmitter in electricity meters sending data to an M2M host will tend to be of a single type or a small number of types. In contrast, an extremely popular web site might be visited by hundreds of different types of devices.
Periodicity of traffic: M2M hosts are likely to have traffic that is periodic in time. For example, a wireless electrical meter that transmits the electrical usage of a residence once every hour. In contrast, humans tend to visit hosts at more irregular intervals.
Specific device types: Hosts of users that use certain kinds of devices are likely to be M2M hosts based on a known correlation between such devices and the hosts they typically communication with.
Specific domain names: Hosts containing strings such as “m2m”, “mdm”, “time”, and “sync” are likely to be M2M hosts.
   These metrics, each of which may be used as an approach to discovering the M2M hosts(s), may also be referred to herein as an “heuristic”.

In accordance with an embodiment, a subset of the above metrics is utilized (i.e., a subset of three: regularity of traffic size, users with low diversity, and few unique device types). For each of these three heuristics a feature value is computed for each host in the data set. A “feature” is a characteristic of the communication traffic associated with a particular M2M client that can be observed and quantified. Illustratively, the values are computed using the well-known Impala SQL Engine for Hadoop data, and stored in a Hadoop cluster. For the regularity of traffic size metric, a computation is made for each flow record of a host, and the number of up bytes is divided by the sum of the number of upstream bytes and the number of downstream bytes. The regularity value is then the standard deviation of these “up/(up+down) fraction” values. As used herein the “up/(up+down) fraction” is a measure of traffic size, rather than, for example, the sum of “up+down bytes”, because the number of packets that are “folded” into a single flow record can sometimes vary, thereby leading to up byte values in records of a host that are multiples of each other. Of course, while three metrics are used in the illustrative embodiment as detailed above, other metrics and any number of metrics may be utilized in determining M2M hosts in accordance with the principles as detailed and further embodiments.

For the user diversity metric, a computation is made of the average number of hosts visited by users of the particular host under study. For this metric type, a computation is made with respect to an exact number of device types occurring in records for that host. This value is normalized because hosts with a large number of unique visitors will tend to have a large number of unique device types. To perform the normalization, the underlying data is used to fit a curve showing the typical number of device types as a function of the number of unique visitors. A computation is then made with respect to a relative number of unique device types by dividing the actual number of unique device types by the typical number of unique device types (given the number of unique visitors to that host).

Using the results from the illustrative example of three metric types, a weighted combination of the three M2M feature values is made to obtain a single M2M value between 0 and 1. This weighted sum may be referred to herein as an “M2M score”. In accordance with the embodiment, a weight of 0.5 is selected for (relative) number of device types, 0.3 for user diversity, and 0.2 for regularity of traffic size. Having computed a single M2M score for each host, it is then useful to sort all hosts according to this value to determine if known M2M hosts are shown to have a high M2M value, and known non-M2M hosts are shown to have a low M2M value.

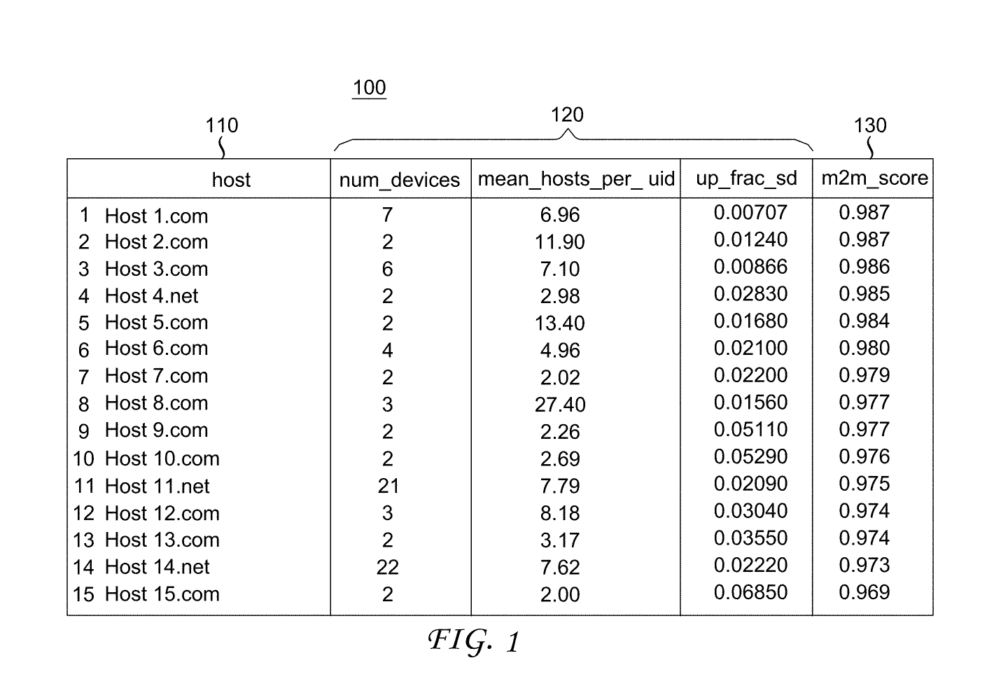

FIG. 1 shows an illustrative M2M host discovery data set 100 in accordance with an embodiment. In particular, a set of fifteen (15) hosts in an exemplary data set is shown for which the M2M score was computed as highest. For each host 110, the host name, the values of the heuristics 120 used, and the M2M score 130 are shown. Examination of the data of FIG. 1 shows higher M2M scores associated with hosts that are more likely to be M2M hosts (e.g., “host1.com”, “host2.com”, “host3.com” and “host4.com”). As such, the M2M scoring scheme, in accordance with the embodiment, may be used to discover M2M hosts. As noted above, M2M hosts are the focus for which anomaly detection is desired in accordance with the embodiments herein. Also, it should be noted that throughout this disclosure the data depicted in certain Figures is merely exemplary in nature and utilized to enhance the understanding of the various embodiments.

In accordance with an embodiment, so-called supervised learning is utilized, where supervised learning is a form of machine learning in which the learning process uses training examples with labels that indicate the class to which each example belongs. For anomaly detection, this means that each training example is labeled either as “anomaly” (i.e., an outlier in some behavior distribution) or “non-anomalous” (i.e., not an anomaly). In accordance with the embodiment, supervised learning is enabled by treating the data from a user of one host as anomalous with respect to another host. That is, user data is collected from multiple hosts, such that in creating training data for a specific host h, data is collected from users of various hosts. Then, if the data comes from a user of host h, that data is labeled as “non-anomalous”, and, conversely, if the data comes from a user of another host, that data is labeled as “anomalous”.

The anomaly detection embodiments herein build a characterization of normal traffic to a particular host by contrasting the data from users of that host to data from users of other hosts. As such, the resultant anomaly detection considers as anomalous (relative to host h) any user data that is unlike normal traffic to that host h. Advantageously, by treating anomaly detection as a supervised learning problem, certain well-known algorithms for supervised learning, such as tree classifiers and Naive Bayes classifiers can be utilized and leveraged for anomaly detection. Further, by using supervised learning, an objective numeric measurement of the performance of the anomaly detector in accordance with the embodiment herein is possible and the ability to measure the accuracy of the anomaly detection is facilitated.

As noted, in accordance with the embodiments, the configuration of an anomaly detector is established by building a classifier through supervised learning. To build the classifier, in accordance with an embodiment, at least the following operations are used: (i) for each input, compute a feature vector; (ii) label each feature vector with a class; (iii) randomly select some of the labeled feature vectors to form a training set; and (iv) train the classifier using the training set. A “feature vector” is a sequence of feature values, e.g. related to a particular M2M client. The input for computing the feature vector consists of one or more flow records from the data received by a host from a user. The computed feature vector is a sequence of feature values.

As will be appreciated, as with most machine learning applications, the choice of features will have a significant impact on the performance on the system. In accordance with some embodiments herein, three approaches for feature selection are utilized (either alone or in combination): (i) look at where a classifier makes classification errors, and then add features intended to prevent these errors; (ii) use feature selection tests, such as information gain, that are designed to show the value of features without the need to build and test a classifier; and (iii) examine the feature relevance scores produced as output by tree classifier training algorithms. Of course, as will be appreciated, there exist any number of other feature selection approaches that may also be utilized in accordance with the principles of the embodiments herein.

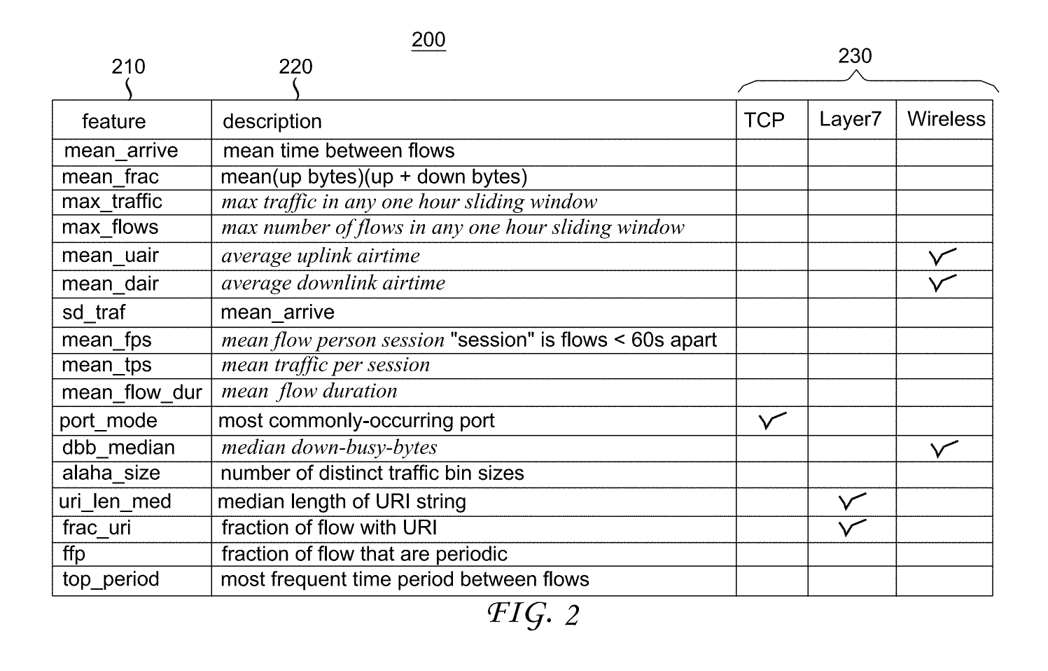

FIG. 2 shows exemplary features 210 in an illustrative feature set 200. The features having description 220 shown in italics are log-10 scaled. The term “traffic” in FIG. 2 refers to the sum of the “up bytes” and “down bytes” fields of flow records. As shown, attributes 230 are attributes of features 210. For example, the “TCP” attribute column indicates features 210 at the level 4 (i.e., the TCP level) in the OSI model of communication systems. Similarly, attribute 230 listed as “Layer 7” refers to features 210 at level 7 (“application layer”) of the OSI model, and attribute 230 listed as “Wireless” indicates features 210 that are wireless-specific. As will be appreciated, wireless-specific features are important to distinguish because an anomaly detector that uses such features typically cannot be immediately used for anomaly detection for wired communications (and vice versa).

Therefore, in accordance with the embodiments, given an M2M host and a user, all flow records associated therewith are collected. These records are then aggregated by the time window to which they belong, and for each user, host, and time window, a feature vector is computed. Thus, each feature vector is identified by a host, user ID, and time window. As such, each computed feature vector is associated with the flow records for the traffic from a user to a host over some time window, and the anomaly detector utilizes a single feature vector as input, and determines (as an output) whether the feature vector is either anomalous or non-anomalous.

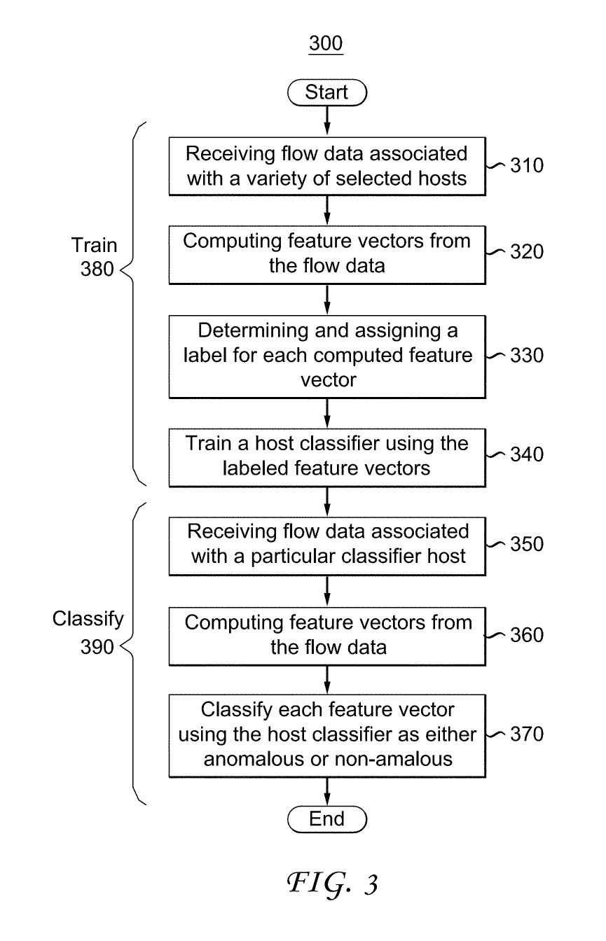

FIG. 3 shows a flowchart of illustrative operations 300 for anomaly detection in accordance with an embodiment. As detailed above, in accordance with an embodiment, anomaly detection is facilitated by using one or more classifiers with each classifier akin to an object that supports two main operations: (i) train—given a set of labeled feature vectors, construct a classifier; and (ii) classify—given a feature vector, determine whether such feature vector is either anomalous or non-anomalous. As shown, steps 310, 320, 330, and 340 comprise train 380 operation, and steps 350, 360, and 370 comprise classify 390 operation.

More particularly, flow data associated with a variety of selected hosts is received at step 310 as input. For example, in selecting flow data for training operation 380, forty (40) hosts might be utilized where twenty (20) of the hosts are M2M hosts for which classifiers are to be constructed, and the other twenty (20) hosts are randomly-selected hosts that have a moderate amount of traffic. As noted above, each classifier constructed is associated with a single host.

From this received flow data, at step 320, feature vectors are computed for each user/host/time window combination (as noted above, the flow data records are aggregated by the user, host and time window to which they belong to), and then labels are determined and assigned, at step 330, to each of the computed feature vectors. In accordance with an embodiment, the label for each feature vector is derived as follows: if the host of the flow records matches the input host name, then the feature is assigned a label “non-anomalous”, otherwise the assigned feature vector label is “anomalous”. As will be seen below, the anomaly detection operations will use “other host” data as a proxy for anomalous data to the targeted host. Using the labeled feature vectors, a host classifier is trained at step 340 thereby completing training operation 380.

Having constructed and trained the host classifier, the classifier can be utilized for anomaly detection. At step 350, flow data associated with a particular classifier host is received. That is, the flow data provided as input consists only of records associated with the host of the anomaly detector. As such, the following principle applies: an anomaly detector for a particular classifier host sees only traffic associated with that classifier host. At step 360, feature vectors are computed from the flow data. However, in this case, the feature vectors are “unlabeled” given they will be the focus and objective of the anomaly detection undertaken. That is, for each user and time window in the input flow data (as represented by the computed feature vectors), the anomaly detector (i.e., the host classifier that has been constructed and trained as detailed above) will classify, at step 370, each feature vector as anomalous or non-anomalous.

As noted above, the illustrative embodiment in selecting flow data for training process 380, utilizes forty (40) hosts where twenty (20) of the hosts are M2M hosts for which classifiers are to be constructed, and the other twenty (20) hosts are randomly-selected hosts that have a moderate amount of traffic. Of course, any number of hosts may be used consistent with the principles of the embodiments. Further, in the event it is impossible to collect data on hosts other than the particular host being monitored for anomalies, the data may be collected, in accordance with an embodiment, by using a uniform distribution for the non-detector hosts; or using a standard (e.g., precalculated from another data source) background distribution.

In accordance with the embodiments herein, a host classifier utilizes at least one classification algorithm (i.e., a general purpose machine learning classifier) such as the well-known tree classifier and/or Naive Bayes classifier. Each of these will now be briefly explained, as well as their integration into the anomaly detection in accordance with the embodiments herein. As will be readily understood, a tree classifier is a decision tree that classifies a feature vector by sequentially making decisions about feature values from the root of the tree to a leaf. Herein, the feature vector is classified as “anomalous” or “non-anomalous” depending on the label of the leaf that the feature vector “reaches”. In accordance with the embodiment, a specific recursive portioning (hereinafter “rpart”) tree classification algorithm is utilized. In training the rpart classifier, given a set of labeled feature vectors, rpart recursively constructs a tree as follows: (i) a feature is selected that best separates the set of feature vectors into “anomalous” and “non-anomalous” subsets. Good separation means that the there is a test of the feature that gives two relatively “pure” subsets; and (ii) the algorithm then continues to recursively apply the same method to the two child nodes of the root node. Each child node will have an associated set of feature vectors. A stopping rule is used to determine when a node in the tree should not be further decomposed. A pruning step may also be used to combine leaf nodes, thereby simplifying the tree. The pruning step is used to avoid so-called “overfitting” which means producing a classifier that is too closely tied to the exact makeup of the training set of feature vectors. Thus, in accordance with an embodiment, the training of a tree classifier for an M2M host is such that a classification tree is constructed for the host. The classifier is operated such that a series of tests on the values in a feature vector are performed, and the classifier's output is either “anomalous” or “non-anomalous” based on the label of the leaf node that is reached.

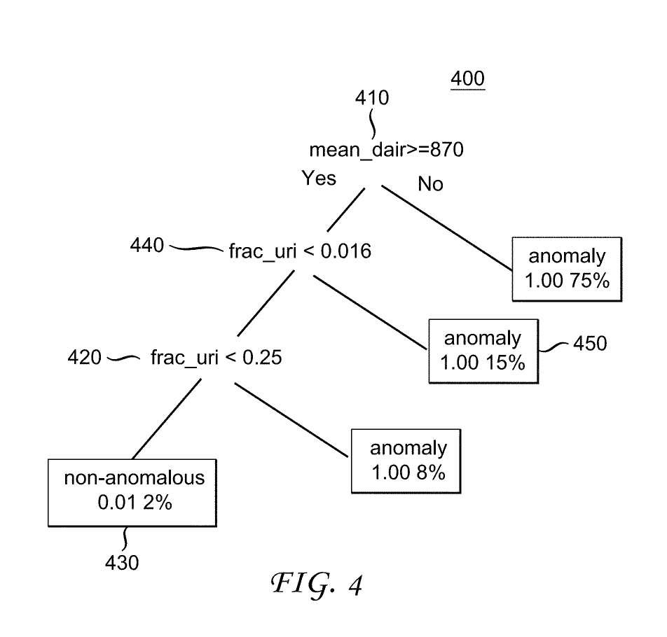

To classify a feature vector, the tree classifier simply “runs” the classifier tree on a feature vector to make a classification decision. FIG. 4 shows an illustrative classification tree 400 for anomaly detection. Suppose the classifier is given a feature vector with the value of feature “mean_dair” as 935. Starting at root node 410, the test proceeds so the left branch of the node is taken leading ultimately to the label 430 of leaf node 420 as “non-anomalous”. In contrast, suppose the value of feature “frac_uri” is 0.21. Then the test frac_uri<0.016 fails, so the right branch is taken, leading to leaf node 440 with label 450 “anomaly” thereby signifying a classification result that is “anomalous”. In sum, in accordance with the embodiment, in training a tree classifier for an M2M host a classification tree for the host is constructed, this host classifier is run such that a series of tests on the values in a feature vector are made, and the classifier output is either “anomalous” or “non-anomalous” based on the label of the leaf node that is ultimately reached.

Turning our attention now to an embodiment of anomaly detection where the host classifier uses Naive Bayes classification, this classifier works by comparing the distribution of feature values of anomalous examples with the feature values of normal examples. For example, suppose a problem under evaluation is determining the sex of a person based on their height and weight (e.g., a height of 165.1 centimeters and a weight of 72.6 kilograms). This method will examine the probability of the height assuming the person is a male, and the probability of the height assuming the person is a female. For example, the probability of a height of 162.6 to 165.1 centimeters is 10% for a female and 5% for a male. Further, the probability of a weight of between 68.0 and 72.6 kilograms is 15% for a female and 20% for a male. Multiplying these height and weight probabilities results in 0.10*0.15=0.015 for a female, and 0.05*0.20=0.01 for a male. Thus, the probability is higher for the assumption of female, so the classification result is female.

In the example above regarding the Naive Bayes classifier, the determination of whether a person was male or female is made based on weight and height measurements. Continuing with this illustrative explanation, the following details will also serve to explain the derivation of the Naive Bayes classifier for the anomaly classification herein. For example, the following derivation aids in understanding how the anomaly classifiers herein add logs of probability ratios, rather than a simple product of probabilities.

More particularly, let w and h be the height and weight measurements given. Let M and F stand for the classes male and female. A guess is made that a person is male if this condition holds:

P(M|w,h)>P(F|w,h) (1).

This means the probability of being male, given the weight and height, is greater than the probability of being female, given the weight and height.

By Bayes' rule (see below), P(M/w, h) in the condition above is equal to:

$$\frac{P ( w , h \vert M ) P ( M )}{P ( w , h )}$$

so condition (1) above can be rewritten as:

P(w,h|M)P(M)>P(w,h|F)P(F) (2).

Bayes' “rule” is a definition of conditional probability and some trivial algebraic manipulation. By definition of conditional probability let P (h|x)=P (x, h)/P (x). One can replace P (x, h) in this expression by P (x|h)P(h), because, again by definition of conditional probability, P (x|h)=P (x, h)/P (h). This gives P(h|x)=(P(x|h)P(h))/P(x), which is Bayes' rule. In interpreting the rule, x can be referred to particular data and h as a hypothesis and, in this case, one can use Bayes' rule to find the probability that some hypothesis holds given the data.

Notice how the P (w, h) terms cancel out. Examining expression P (w, h|M) shows the “naive” in “Naive Bayes” refers to using the following approximation:

$$P ( w , h \vert M ) = P ( w \vert h , M ) P ( h \vert M ) \approx P ( w \vert M ) P ( h \vert M )$$

which holds exactly if weight and height are independent given that the sex is male. Adopting this assumption, condition 2 above can be written as:

P(w|M)P(h|M)P(M)>P(w|F)P(h|F)P(F)

which, dividing both sides by the right-hand side, is equivalently

$$\frac{P ( w \vert M ) P ( h \vert M ) P ( M )}{P ( w \vert F ) P ( h \vert F ) P ( F )} > 1.$$

Factoring, and taking the log of both sides results in:

$$log ( \frac{P ( w \vert M )}{P ( w \vert F )} ) + log ( \frac{P ( h \vert M )}{P ( h \vert F )} ) + log ( \frac{P ( M )}{P ( F )} ) > 0$$

Algorithmically, this means the classification can be performed by looking at features one at a time, comparing the male and female case. Also, it means that we can see how much each feature contributes to a classification of either male or female. For example, if the first term above is positive, then weight taken on its own suggests the classification should be male. A large positive value suggests much confidence in the judgement of “male”, and conversely for a large negative value. Finally, note that the last term above can equivalently be written log(P (M)/(1−P (M))).

In accordance with an embodiment, the training of a Naive Bayes classifier takes labeled feature vectors as input and produces distributions of the feature values. In the case of anomaly detection, there will be separate distributions for the feature values in vectors labeled as “anomalous”, and feature values in the vectors labeled as “non-anomalous”.

To perform the classification, the probability calculations described above are performed in accordance with several further details. First, because the probabilities being multiplied are small, and because the number of features are large, one must take care to avoid underflow and other sources of numerical error. For this reason, the host classifier will add the logs of the probabilities, rather than multiplying the probabilities directly. Second, there may be occasion where the features include both numerical and categorical features. To address this scenario, well-known “Laplace Smoothing” is used. Third, when using Naive Bayes there needs to be specification of the prior probabilities for the classes. In anomaly detection, this means to specify the probability of an anomaly. Specifying this probability, as will be appreciated, is a somewhat difficult task to perform with a high degree of confidence. As such, in accordance with an embodiment a 0.001 probability is specified (i.e., one in a thousand of user observations will be anomalous).

The implementation of the Naive Bayes classifier utilized by the embodiment supports various distributions, and allows for the selection of the appropriate distribution for each feature. In particular, so-called “kernel density estimators” are used to model distributions of features having numeric values, and simple mass functions (with Laplace Smoothing) to model distributions of features having discrete values. This facilitates the estimation of the needed distributions from the training data. For example, in some number of packages for Naive Bayes classification, it is assumed that the training values for a feature lie in a normal (i.e., Gaussian) distribution. In many cases, the feature values may have a distribution that is non-Gaussian which will lead to poor classification results if a Gaussian assumption is used. As such, to address at least this issue, the host classifier supports various distributions, and allows the selection of the appropriate distribution for each feature.

To summarize, to train a Naive Bayes classifier an estimate of the distributions of feature values (for both the anomalous and non-anomalous cases) is made given the labeled training data. To classify, a comparison is made of the joint probabilities of all the features for the “anomalous” and “non-anomalous” cases.

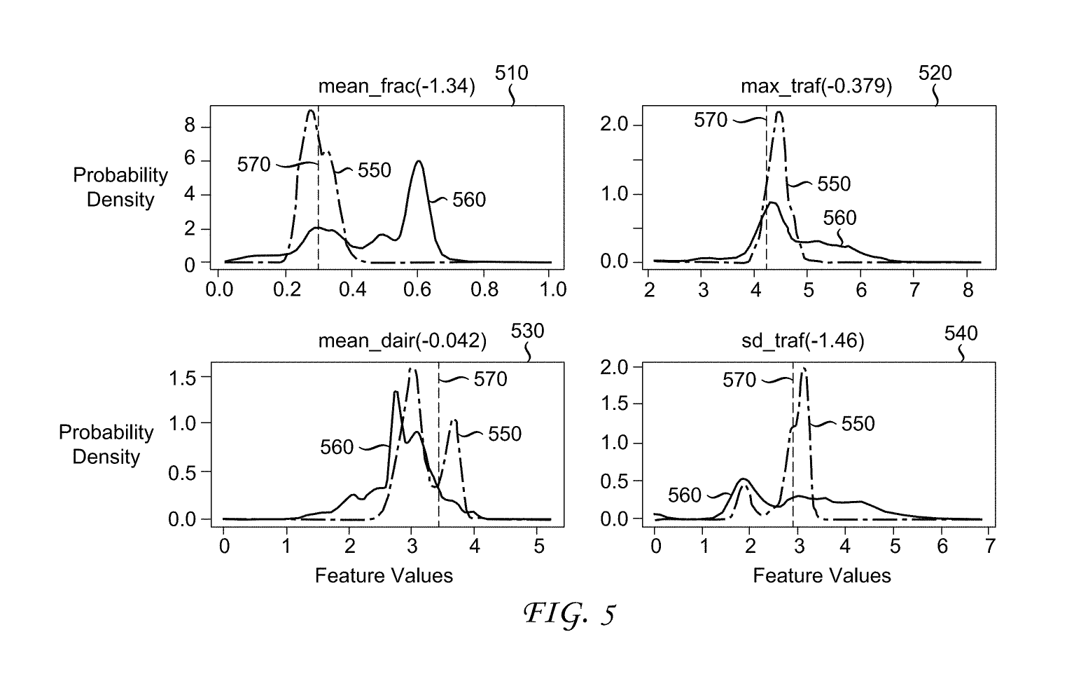

FIG. 5 shows a series of graphs for an example of using Naive Bayes classification in a host classifier for anomaly detection in accordance with an embodiment. The four graphs, i.e., graph 510, graph 520, graph 530, and graph 540, correspond to four of the features in an illustrative feature vector. In each graph, the estimated probability density 550 is shown for the training examples with the label “non-anomalous”, and the estimated probability density 560 is shown for the examples having a label “anomalous”. As shown, the x-axis covers the range of feature values. Line 570 in the respective graphs shows the feature values for an unlabeled test example.

In accordance with an embodiment, multiple classifiers may be used in combination with anomaly detection reported in several ways (either alone or in some combination): (i) report an anomaly if all detectors report an anomaly; (ii) report an anomaly if any detector reports an anomaly; and (iii) report an anomaly if the majority of detectors reports an anomaly. While each reporting methodology may be used, the first option of reporting an anomaly if all detectors report an anomaly provides the most consistent results.

As noted above, the anomaly detection embodiments determine whether a user of an M2M host is behaving anomalously (on some day or some given time). As such, the embodiments perform the anomaly detection for users on an individual basis. Of course, it may be that the traffic at an M2M host is anomalous, not because any one user is anomalous on his own, but because there are many more users (or fewer users) than usual (i.e., a large spike or drop in the number user on a collective basis.

In accordance with a further embodiment, a computation of certain traffic statistics is made for an M2M host and then a so-called “change detection” algorithm (e.g., the well-known detection of changes using cumulative sum (CUSUM) algorithm) is employed in the anomaly detection. For example, one such statistic could be the total hourly traffic to the M2M host, or the total number of hourly flows to the M2M host. As such, the anomaly classification is augmented with change detection.

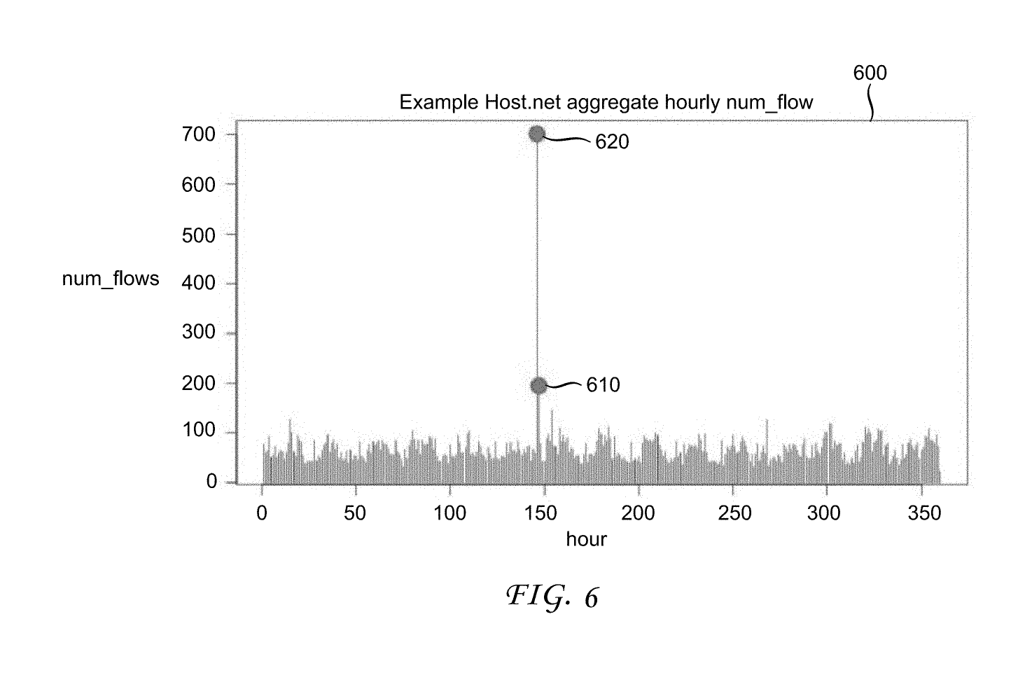

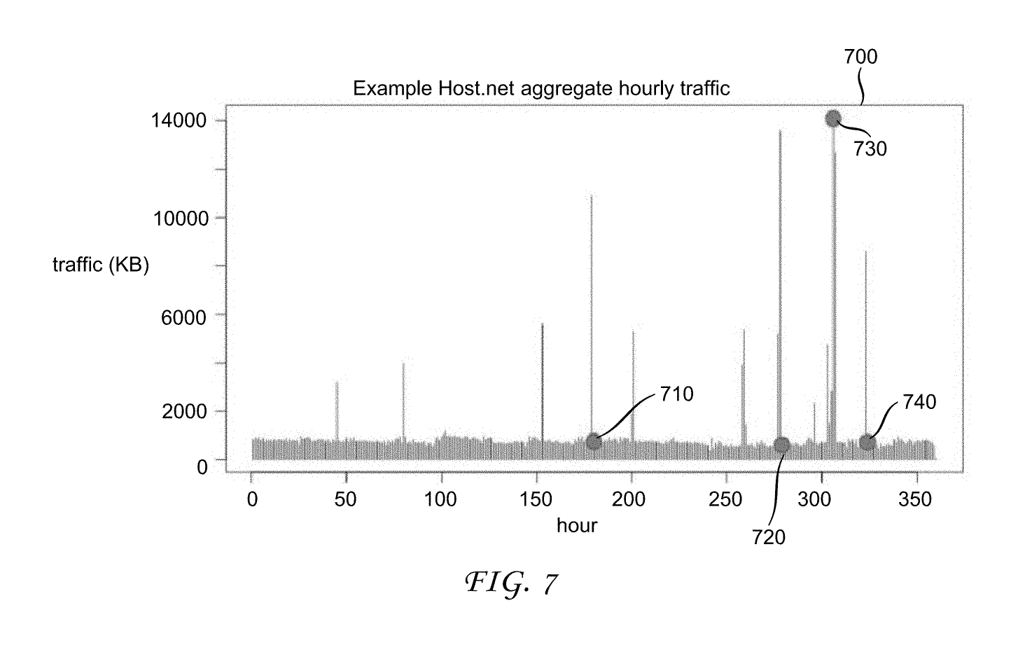

FIG. 6 shows a graph 600 of detected anomalies in a number of flow records sent to a host (i.e., “examplehost.net”) in accordance with an embodiment. Graph 600 shows the number of flows sent to the host, aggregated by hour, with anomalous hours detected (i.e., anomaly 610 and anomaly 620). FIG. 7 shows a graph 700 of detected anomalies (i.e., anomaly 710, 720, 730, and 740) in traffic (i.e., number of upstream and downstream bytes) of traffic to a host in accordance with an embodiment. An issue with the use of the CUSUM algorithm is that its behavior is controlled by two parameters: thresh and drift. In the embodiment, an algorithm is used to estimate the drift parameter, and the thresh parameter is a single input value from the user. The CUSUM algorithm can be written to separately looks for changes in the “upstream” (increasing value) and “downstream” directions. This is useful, as it is plausible that one might be interested in only anomalies associated with large increases in traffic (because network performance may be affected negatively), and not with large decreases in traffic.

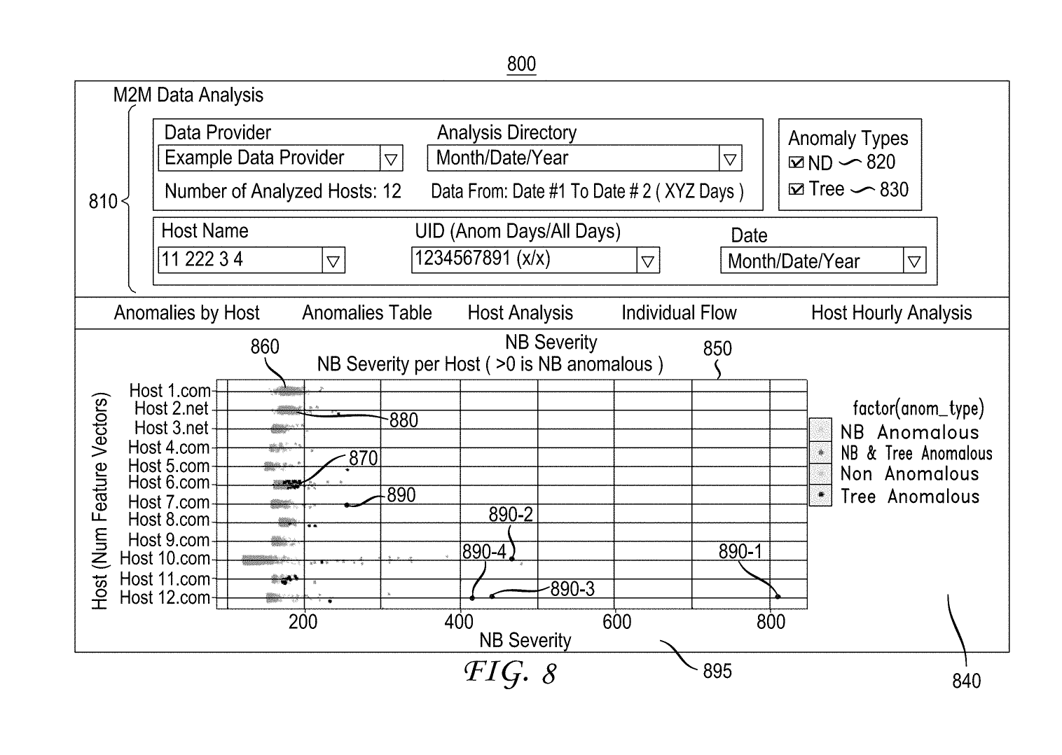

FIG. 8 shows a display interface 800 for an anomaly detection application, including an illustrative display of anomalies detected using Naive Bayes classification, in accordance with an embodiment. Illustratively, the application may be web-based and, in accordance with an embodiment, display interface 800 facilitates the display and examination of the results from the anomaly detection system. For example, display interface 800 may be used if a wireless service provider has anomaly detectors for a set of M2M hosts, and wants to examine and digest a set of anomaly report(s). Through a visual inspection using display interface 800, the operator can determine which M2M hosts have the most anomalies, which time periods have the most anomalies, which users have many anomalies, which anomalies are the most severe, and/or the cause(s) of a particular anomaly. In this way, an operator can take immediate action to address an anomaly, including deciding whether the detected anomaly is a “true” anomaly in accordance with the operator's judgment after reviewing results on display interface 800.

As shown, display interface 800 allows for a selection from data directory 810 (i.e., the directory being produced by executing the anomaly detector, and containing all inputs as detailed above), and allows for one or both of the anomaly detectors (i.e., detector 820 and detector 830) to be selected. There are additional fields in data directory 810 for allowing the user to select a specific M2M host, user, and/or date. Display interface 800 also provides a high-level display 840 of traffic from all users of all M2M hosts in the data set allowing for a visualization of all detected anomalies form all M2M hosts. Each point in the illustrative graph 850 corresponds to a user of an M2M host on a specific day. The y-axis shows the M2M hosts and the x-axis shows the anomaly severity level 895 from the perspective of Naive Bayes classifier 820. For anomaly severity level 895 depiction, each point is uniquely shown (e.g., different colors or shades) according to an anomaly status. For example, points 860 (e.g., a gold color or first shade) are host/user/days that are regarded as non-anomalous. Points 870 (e.g., a black color or second shade) are anomalous by tree classifier 830 only, points 880 (e.g., a blue color or third shade) are anomalous by Naive Bayes classifier 820 only, and points 890 (e.g., a red color or fourth shade) are anomalous by both classifiers. Points 890-1, 890-1, 890-3 and 890-4 to the right of the graph are regarded as anomalous by both classifiers and are considered severe anomalies by the Naive Bayes classifier.

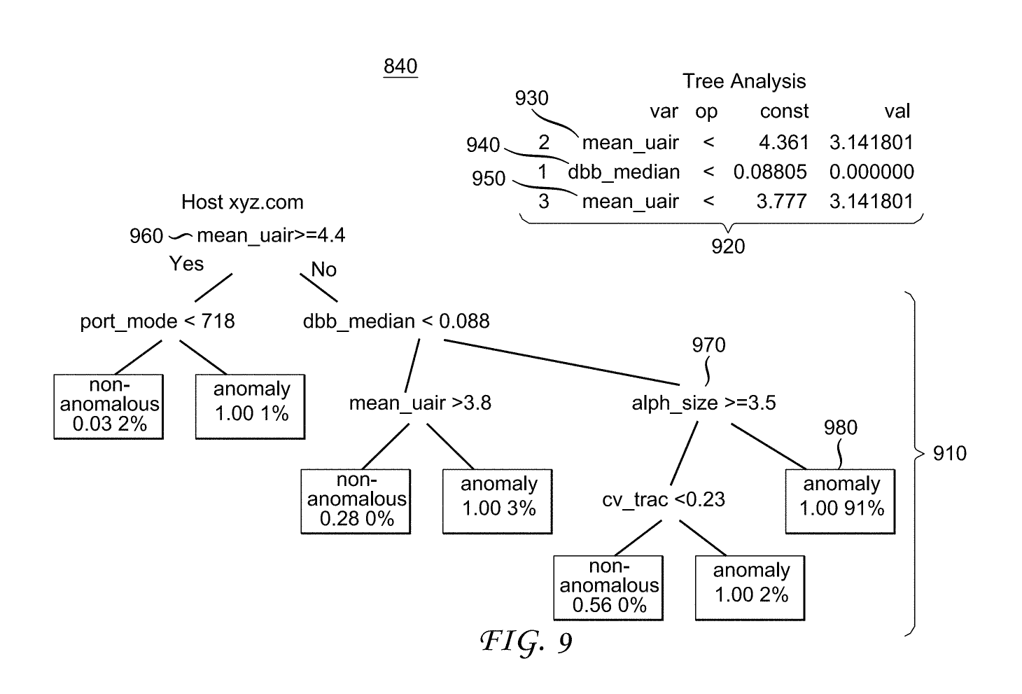

FIG. 9 shows a display of anomalies, using display interface 800 of FIG. 8, detected using a tree classifier in accordance with an embodiment. In particular, display 840 shows anomalies reported by tree classifier 830, configured as detailed above, in accordance with an embodiment. As shown, classification tree 910 shows the anomaly detection results for M2M host “hostXYZ.com”. Informational box 920 describes how values in the feature vector define a path in the tree from root node 960 to leaf node 970 and labeled as anomalous (i.e., label 980). For example, condition 930 is mean uair<4.361, and the feature vector contained a value of 3.142 for this feature. Therefore, the right branch of classification tree 910 was taken from the root node of classification tree 910. In the same fashion, conditions 940 and 950 relate to the path in classification tree 910 to anomalous leaf node 970.

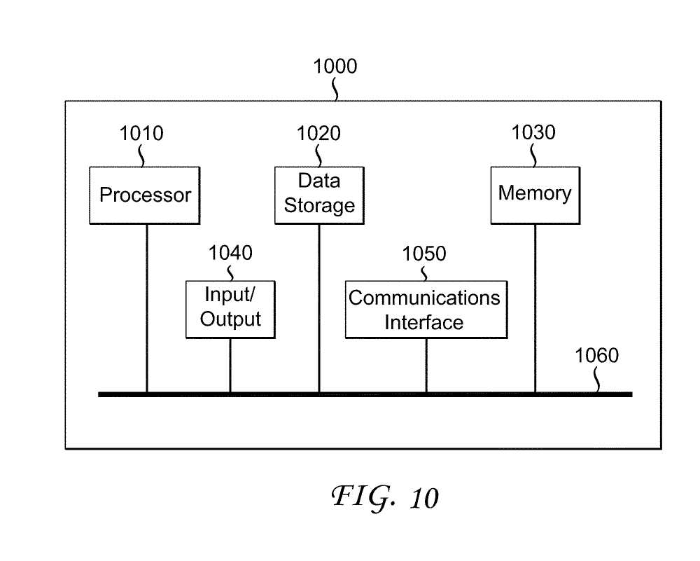

As detailed above, the various embodiments herein can be embodied in the form of methods and apparatuses for practicing those methods. The disclosed methods may be performed by a combination of hardware, software, firmware, middleware, and computer-readable medium (collectively “computer”) installed in and/or communicatively connected to a user device. FIG. 10 is a high-level block diagram of an exemplary computer 1000 that may be used for implementing a method for anomaly detection in accordance with the various embodiments herein. Computer 1000 comprises a processor 1010 operatively coupled to a data storage device 1020 and a memory 1030. Processor 1010 controls the overall operation of computer 1000 by executing computer program instructions that define such operations. Communications bus 1060 facilitates the coupling and communication between the various components of computer 1000. The computer program instructions may be stored in data storage device 1020, or a non-transitory computer readable medium, and loaded into memory 1030 when execution of the computer program instructions is desired. Thus, the steps of the disclosed method (see, e.g., FIG. 3) and the associated discussion herein above) can be defined by the computer program instructions stored in memory 1030 and/or data storage device 1020 and controlled by processor 1010 executing the computer program instructions. For example, the computer program instructions can be implemented as computer executable code programmed by one skilled in the art to perform the illustrative operations defined by the disclosed method. Accordingly, by executing the computer program instructions, processor 1010 executes an algorithm defined by the disclosed method. Computer 1000 also includes one or more communication interfaces 1050 for communicating with other devices via a network (e.g., a wireless communications network) or communications protocol (e.g., Bluetooth®). For example, such communication interfaces may be or include a receiver, transceiver or modem for exchanging wired or wireless communications in any number of well-known fashions. Computer 1000 also includes one or more input/output devices 1040 that enable user interaction with computer 1000 (e.g., camera, display, keyboard, mouse, speakers, microphone, buttons, etc.).

Processor 1010 may include both general and special purpose microprocessors, and may be the sole processor or one of multiple processors of computer 1000. Processor 1010 may comprise one or more central processing units (CPUs), for example. Processor 1010, data storage device 1020, and/or memory 1030 may include, be supplemented by, or incorporated in, one or more application-specific integrated circuits (ASICs) and/or one or more field programmable gate arrays (FPGAs).

Data storage device 1020 and memory 1030 each comprise a tangible non-transitory computer readable storage medium. Data storage device 1020, and memory 1030, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1040 may include peripherals, such as a camera, printer, scanner, display screen, etc. For example, input/output devices 1040 may include a display device such as a cathode ray tube (CRT), plasma or liquid crystal display (LCD) monitor for displaying information to the user, a keyboard, and a pointing device such as a mouse or a trackball by which the user can provide input to computer 1000.

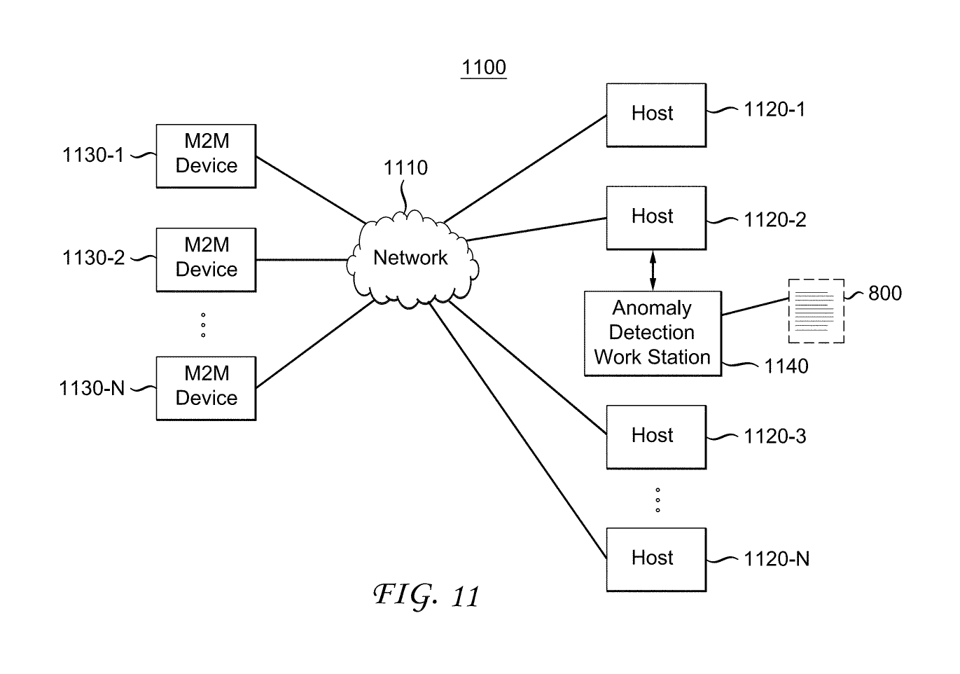

FIG. 11 is a diagram of an illustrative anomaly detection environment 1100 in accordance with an embodiment. As shown, anomaly detection environment 1100 includes a plurality of hosts, i.e., host 1120-1, host 1120-2, 1120-3, and host 1120-N communicating over network 1110 to a plurality of M2M devices, i.e., M2M device 1130-1, M2M device 1130-2, and M2M device 1130-N. M2M devices 1130-1 through 1130-N may include any device that is capable of communicating across network 1110 with hosts 1120-1 through 1120-N such as a smartphone, tablet, computer, sensor, meter, home security device, and/or any type of Internet-of Things (IOT) device, to name just a few. Network 1110 may be any type of communications network (or combinations thereof) such as a public switched telephone network (PSTN), cellular network, fiber optic network, cable network, cloud computing network, and/or the Internet, to name just a few. Hosts 1120-1 through 1120-N may include one or more servers, one or more workstation computers, and/or one or more virtual machines, to name just a few.

As shown, and as detailed above, one or more M2M devices 1130-1 through 1130-N may generate M2M information (i.e., flow data) and communicate the same through network 1110 to one or more of hosts 1120-1 through 1120-N. Illustratively, host 1120-3 may be interested in monitoring and detecting anomalous M2M traffic, and is in communication with anomaly detection workstation 1140 for such purposes. Anomaly detection workstation 1140 (configured, for example, as shown in FIG. 10) will perform the anomaly detection operations detailed above including using the display interface 800 of FIG. 8 to display the results of anomaly detection for the targeted host, e.g., host 1120-3.

The number of M2M devices, hosts, computers, and networks shown in FIG. 11 are illustrative in nature and it will be understood that any number of such devices, hosts, computers, and/or networks may be utilized. Further, multiple hosts (computers, or devices) may be combined into one, for example, host 1120-3 and anomaly detection workstation 1140 may be combined into a single hardware device (including their associated operations).

It should be noted that for clarity of explanation, the illustrative embodiments described herein may be presented as comprising individual functional blocks or combinations of functional blocks. The functions these blocks represent may be provided through the use of either dedicated or shared hardware, including, but not limited to, hardware capable of executing software. Illustrative embodiments may comprise digital signal processor (“DSP”) hardware and/or software performing the operation described herein. Thus, for example, it will be appreciated by those skilled in the art that the block diagrams herein represent conceptual views of illustrative functions, operations and/or circuitry of the principles described in the various embodiments herein. Similarly, it will be appreciated that any flowcharts, flow diagrams, state transition diagrams, pseudo code, program code and the like represent various processes which may be substantially represented in computer readable medium and so executed by a computer, machine or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
receiving first flow data associated with a plurality of hosts;
computing a first plurality of feature vectors from the first flow data;
assigning a label to each feature vector of the first plurality of feature vectors;
training a host classifier using particular ones of the labeled feature vectors of the first plurality of feature vectors;
receiving second flow data associated with a target host, the target host included in the plurality of hosts;
computing a second plurality of feature vectors from the second flow data; and
classifying one or more of the feature vectors from the second plurality of feature vectors using the trained host classifier.

2. The method of claim 1, wherein the classifying operation further comprises:
designating whether the one or more feature vectors is either anomalous or non-anomalous with respect to the target host.

3. The method of claim 2 wherein the plurality of hosts includes a set of machine-to-machine (M2M) hosts.

4. The method of claim 3 wherein the first flow data includes data from particular ones of the M2M hosts.

5. The method of claim 1 wherein the first flow data comprises one or more flow records associated with a respective host of the plurality of hosts, and each flow record is defined by data received by the respective host during a particular time window.

6. The method of claim 5 wherein the assigning the label to the feature vector further comprises:
comparing, for each flow record of the one or more flow records associated with the respective host, whether the data defining the flow record is associated with a user of the target host, and if so, assigning the label with a designation as non-anomalous with respect to the target host, otherwise, assigning the label with a designation as anomalous with respect the target host.

7. The method of claim 1 further comprising:
associating the host classifier with a particular one host of the plurality of hosts.

8. The method of claim 2 wherein the host classifier uses one of a Naive Bayes classifier and a tree classifier.

9. The method of claim 2 wherein the providing the first flow data further comprises:
selecting a set of metrics based on an association with a plurality of M2M hosts;
computing, for each host of the plurality of hosts, an M2M score using the set of metrics; and
designating particular ones of the plurality of hosts as M2M hosts based on the M2M score computed for the particular ones of the hosts.

10. The method of claim 5 wherein each feature vector of the first plurality of feature vectors is identified by a host name, a user identification, and a time window.

11. An apparatus comprising:
a communications interface for receiving first flow data associated with a plurality of hosts, and second flow data associated with a target host, the target host included in the plurality of hosts; and
a processor configured to:
compute a first plurality of feature vectors from the first flow data;
assign a label to each feature vector of the first plurality of feature vectors;
train a host classifier using particular ones of the labeled feature vectors of the first plurality of feature vectors;
compute a second plurality of feature vectors from the second flow data; and
classify one or more of the feature vectors from the second plurality of feature vectors using the trained host classifier.

12. The apparatus of claim 11 wherein the classify the one or more feature vectors includes and the processor is further configured to:
designate whether the one or more feature vectors is either anomalous or non-anomalous with respect to the target host.

13. The apparatus of claim 11, wherein the first flow data comprises one or more flow records associated with a respective host of the plurality of hosts, and each flow record is defined by data received by the respective host during a particular time window.

14. The apparatus of claim 13 wherein the assigning the label to the feature vector includes and the processor is further configured to:
compare, for each flow record of the one or more flow records associated with the respective host, whether the data defining the flow record is associated with a user of the target host, and if so, assign the label with a designation as non-anomalous with respect to the target host, otherwise, assign the label with a designation as anomalous with respect the target host.

15. The apparatus of claim 11 wherein the plurality of hosts includes a set of machine-to-machine (M2M) hosts, and the first flow data includes data from particular ones of the M2M hosts.

16. The apparatus of claim 11 wherein each feature vector of the first plurality of feature vectors is identified by a host name, a user identification, and a time window.

17. The apparatus of claim 15 wherein the providing the first flow data includes and the processor is further configured to:
select a set of metrics based on an association with a plurality of M2M hosts;
compute, for each host of the plurality of hosts, an M2M score using the set of metrics; and
designate particular ones of the plurality of hosts as M2M hosts based on the M2M score computed for the particular ones of the hosts.

18. A non-transitory computer-readable medium storing computer program instructions for anomaly detection, the computer program instructions, when executed on a processor, cause the processor to perform operations comprising:
receiving first flow data associated with a plurality of hosts;
computing a first plurality of feature vectors from the first flow data;
assigning a label to each feature vector of the first plurality of feature vectors;
training a host classifier using particular ones of the labeled feature vectors of the first plurality of feature vectors;
receiving second flow data associated with a target host, the target host included in the plurality of hosts;
computing a second plurality of feature vectors from the second flow data; and
classifying one or more of the feature vectors from the second plurality of feature vectors using the trained host classifier.

19. The non-transitory computer-readable medium of claim 18 wherein the classifying operation further comprises:
designating whether the one or more feature vectors is either anomalous or non-anomalous with respect to the target host.

20. The non-transitory computer-readable medium of claim 19 wherein the first flow data comprises one or more flow records associated with a respective host of the plurality of hosts, and each flow record is defined by data received by the respective host during a particular time window, and the assigning the label to the feature vector operation further comprises:
comparing, for each flow record of the one or more flow records associated with the respective host, whether the data defining the flow record is associated with a user of the target host, and if so, assigning the label with a designation as non-anomalous with respect to the target host, otherwise, assigning the label with a designation as anomalous with respect the target host.
